(19) United States
(12) Patent Application Publication
(10) Pub. No.: US 2013/0121704 A1
(43) Pub. Date: May 16, 2013

(54) UTILITIES COMMUNICATIONS MODULE WHICH ENABLES REMOTE COMMUNICATIONS VIA AN OPTICAL FIBER NETWORK

(71) Applicant: Pangrac and Associates Development, Inc., Angel Fire, NM (US)

(72) Inventors: Donald T. Gall, Port Aransas, TX (US); David M. Pangrac, Angel Fire, NM (US)

(73) Assignee: PANGRAC AND ASSOCIATES DEVELOPMENT, INC., Angel Fire, NM (US)

(21) Appl. No.: 13/678,616

(22) Filed: Nov. 16, 2012

Related U.S. Application Data
(60) Provisional application No. 61/560,377, filed on Nov. 16, 2011.

(51) Int. Cl. H04B 10/00

(52) U.S. Cl. CPC H04B 10/12
USPC 398/116

(57) ABSTRACT

A utilities communications module including an optical fiber interface, an optical modem and at least one utilities interface. The optical fiber interface enables remote communications via an optical network. The optical modem converts between optical and electrical communications. The utilities interface enables remote communications with at least one local utility device. The utilities communications module enables remote control and communications with one or more utility devices and other service devices, such as utility meters (e.g., electric, gas, water, etc.) including smart meters and the like, home monitoring controllers, home security controllers, smart home controllers, etc.

### CROSS-REFERENCE TO RELATED APPLICATIONS

This application claims the benefit of U.S. Provisional Application Ser. No. 61/560,377, filed on Nov. 16, 2011, which is hereby incorporated by reference in its entirety for all intents and purposes.

### BACKGROUND OF THE INVENTION

1. Field of the Invention

This invention relates in general to the field of utilities communications, and more particularly to a utilities communications module which enables communications with local utility and other service devices via an optical fiber network.

2. Description of the Related Art

The term “utilities” (or simply, “utility” or the like) as used herein may include the conventional connotations, such as associated with electric utilities, gas utilities, water utilities, etc. The term “utilities” as used herein may further include other types of commercial or residential services and corresponding devices, such as, for a non-exhaustive list of examples, security systems, heating, ventilating and air-conditioning (HVAC) systems, light controllers, swimming pool controllers, home theater devices, network communication systems, etc.

There is a growing field of applications for intelligent monitoring and management of utilities and other customer devices. “Smart Grid,” for example, is a concept being championed by the power industry to make the entire power grid infrastructure intelligent enough to be more efficient and reliable. Smart Grid services may include automatic (or automated) meter reading (AMR) to enable reading of electric meter information from a remote location. Smart Grid services may further include advanced metering infrastructure (AMI) which enables bidirectional or two-way communications with the meter, such as remote control of power usage and various electronic systems and devices such as power structures and even household devices. One of the biggest logistics problems for the electrical distribution segment of the industry implementing the Smart Grid strategy is providing the communications with the electric meter and the various electronic devices.

Similarly, the efficient allocation of resources by the gas distribution industry depends on receiving accurate and timely data from the distributed propane gas storage tanks which may be equipped with smart metering devices. Additionally, the need for home security and safety for residential customers increasingly depends on remote alarming and management of the home security devices so that they can be remotely monitored and controlled. This includes viewing of video monitoring cameras on the premises from anywhere. A growing number of residential and small business dwellings are instrumented with intelligent heat and air conditioning controllers, and the effective management of these energy saving devices requires network access from remote locations.

### SUMMARY OF INVENTION

A utilities communications module according to one embodiment includes an optical fiber interface, an optical modem and at least one utilities interface. The optical fiber interface enables remote communications via an optical network. The optical modem converts between optical and electrical communications. The utilities interface enables remote communications with at least one local utility device.

The optical fiber interface may be implemented in any suitable manner, and may include either an optical coupler or an optical tap or the like for interfacing an optical fiber. The optical fiber interface may further include an optical transceiver or the like.

The utilities interface(s) may include a meter interface which enables interfacing with at least one local meter. The meter interface may be a smart meter interface or the like which enables communications with at least one local smart meter, such as any one or more smart electric meters, smart gas meters, smart water meters, etc. Each utilities interface may enable remote meter reading, and may further support more sophisticated two-way communications and control.

Each utilities interface may be implemented as a local network interface, including any combination of wired or wireless configurations for interfacing compatible network-configured devices. The network interface may be enabled for a single device, or may implement a local area network (LAN) or wide area network (WAN) or the like for interfacing multiple utility and/or service devices.

The utilities communications module may include a power supply, which receives power from any one or more internal or external sources, such as a local smart meter, Power Over Ethernet, solar panels, etc.

One or more utilities interfaces may enable bidirectional communications with at least one home monitoring controller. One or more utilities interfaces may enable bidirectional communications with at least one home security controller. One or more utilities interfaces may enable bidirectional communications with at least one smart home controller.

### BRIEF DESCRIPTION OF THE DRAWINGS

The benefits, features, and advantages of the present invention will become better understood with regard to the following description and accompanying drawings, in which:

FIG. 1 is a figurative view of an FTTH network configuration including a utilities communications module implemented according to one embodiment of the present invention;

FIG. 2 is a block diagram of an exemplary embodiment of a utilities communications module (UCM) which may be used as the module of FIG. 1;

FIG. 3 is a block diagram of another exemplary embodiment of a UCM which may be used as the module of FIG. 1;

FIG. 4 is a block diagram of another exemplary embodiment of a UCM which may be used as the module of FIG. 1; and

FIG. 5 is a block diagram of an exemplary UCM which may be configured according to any of the UCM configurations described herein for interfacing utilities devices implemented according to any of the communication interfaces described herein.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

Fiber optic networks are being deployed to provide network communications for many different types of customers, including household and commercial customers located in urban and rural areas. Fiber technology includes hybrid fiber coax (HFC), fiber to the premises (FTTP), and fiber to the home (FTTH). FTTP and FTTH are hereby both generally referenced as FTTH. Most FTTH networks have a network interface device (NID), including, for example, an optical network terminal (ONT) or a network interface unit (NIU), installed on or near the home which becomes an obstacle and a signal security problem. This is because many of the NIDs are powered from inside the home which is not acceptable for electrical billing and reliability.

FTTH networks are being installed into many rural communities by traditional electric companies. This provides the desired bandwidth, but the current method for integrating communication telemetry into conventional communication networks does not work in the typical rural deployment. For example, rural electric cooperatives may mount the electrical meter on a pole or pedestal that is up to several hundred feet away from the house.

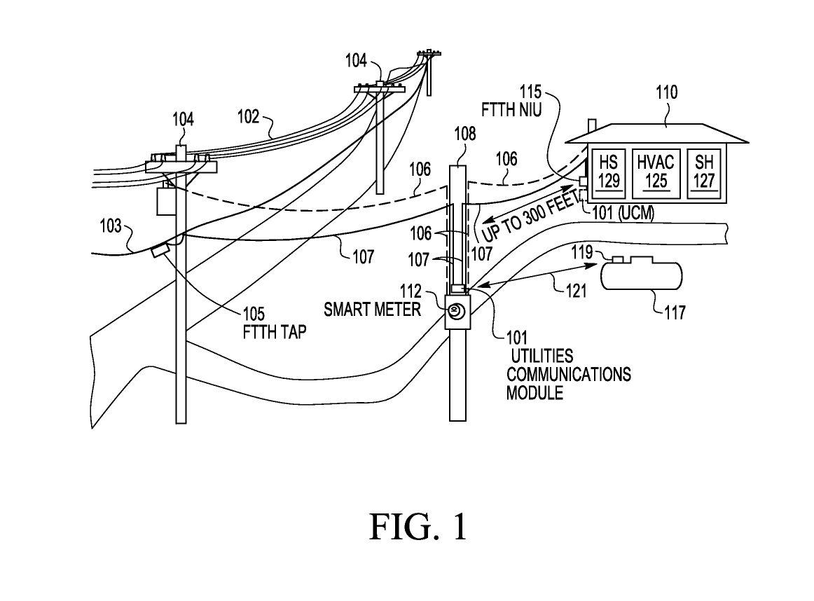

FIG. 1 is a figurative view of an FTTH network configuration including a utilities communications module (UCM) 101 implemented according to one embodiment of the present invention. Power lines 102 are distributed within an area, such as a rural area or the like, along main utility poles 104 traversing the area, such as along a roadway or street or the like. A power line extension 106 (shown as dashed line) is tapped from the main power lines 102 at a nearby utility pole 104 and routed to a local utility pole 108 for servicing a nearby house 110. The power line extension 106 is routed to an electric smart meter 112 mounted on the local utility pole 108, and then to the house 110 as understood by those of ordinary skill in the art. In the illustrated embodiment, the local utility pole 108, if provided, may be located a significant distance from the house 110, such as several hundred feet.

The electric smart meter 112 is only one example of a smart meter. Other types of smart meters are contemplated, such as smart gas meters, smart water meters etc. Any one or more of the utility meters may also be regular or less sophisticated meters with limited communication capabilities, such as for meter reading or external power control or the like. Also, the UCM 101 may be configured for communications with multiple utility meters, such as different meter types and/or multiple meters of a common type. The UCM 101 may be configured, for example, to enable communications with multiple utility meters of a multifamily dwellings, such as an apartment complex or the like.

The UCM 101 may be mounted to the local utility pole 108 adjacent to (or nearby) the smart meter 112. At least one fiber optic cable 103 is routed along the main utility poles 104. An FTTH tap 105 provides an interface between the fiber optic cable 103 and a fiber segment 107 to enable fiber communication support to the house 110. The fiber segment 107 is routed to the local utility pole 108, to the UCM 101, and then to an FTTH NIU 115 mounted on or near the house 110. The UCM 101 is configured as a stand-alone optical to electrical interface as further described herein. It is relatively transparent and compatible to the existing FTTH environment and is easily configured to be as low cost as possible. In one embodiment, the UCM 101 may be powered by the smart meter 112. The UCM 101 is an optical-electrical conversion device that may have a very low optical insertion loss while providing a communications interface to various local devices, which may include the smart meter 112.

A utility tank 117 is also illustrated, such as a gas tank (e.g., natural gas, propane, etc.) or a water tank or the like. The utility tank 117 may be buried or above-ground. A utility meter 119 is mounted on the utility tank 117. The UCM 101 is configured to provide a communications interface with the utility meter 119 via a communication link 121. The utility meter 119 may be a regular meter with limited communication capability, in which the UCM 101 may simply provide remote meter reading and/or remote powering. Alternatively, the utility meter 119 may also be a smart meter similar to the smart meter 112 in which more sophisticated communications may be enabled. The communication link 121 may be configured in a similar manner as the communication link with the smart meter 112. Alternatively, as described herein, the utility meter 119 may be configured with wired network capability or wireless network capabilities for communicating with the UCM 101.

In another configuration, the UCM 101 is alternatively located at or adjacent the house 110 as shown with dashed lines. The UCM 101 may communicate with the smart meter 112 and/or the utility meter 119 in the same manner, or via other wired or wireless communications as further described herein. The smart meter 112 may alternatively be located at or adjacent the house and near or adjacent the UCM 101. Alternatively, the UCM 101 may be interfaced with the FTTH NIU 115.

Location at or adjacent the 110 may facilitate more reliable communications with other types of utilities and services, such as a home security (HS) system 123, and/or an HVAC system 125, and/or a smart home controller 127 and/or the like. In this manner, the UCM 101 enables uni-directional or bidirectional communications with devices for a variety of utilities and/or services, such as various utility services, security systems, heating, HVAC systems, light controllers, swimming pool controllers, home theater devices, network communication systems, etc.

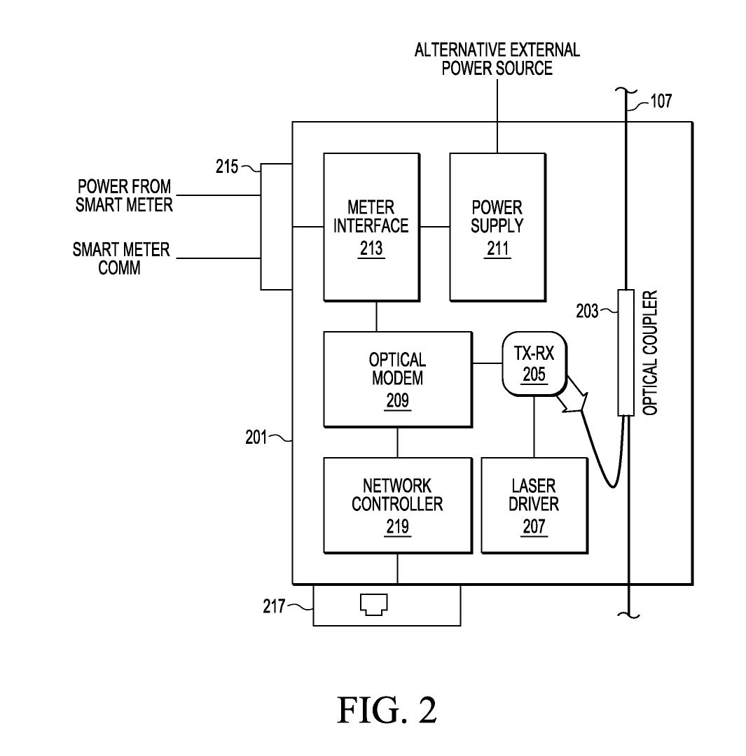

FIG. 2 is a block diagram of an exemplary embodiment of a UCM 201 which may be used as the module 101. The UCM 201 includes an optical interface for sending and receiving communications via the fiber segment 107 (and thus with cable 103). For the UCM 201, the optical interface includes an optical coupler 203, an optical transceiver 205 to transmit (TX) and receive (RX) optical communications via the fiber segment 107, and a laser driver 207. The optical interface is coupled to an optical modem 209 which performs conversion between electrical and optical communications. The UCM 201 further includes a power supply 211.

The optical modem 209 may be implemented according any one or more suitable configurations, such as, for example, RFoG (radio frequency over glass) or GPON (gigabyte passive optical network) or the like. In the RFoG version of FTTH, the optical modem 209 may be a DOCSIS (data over cable service interface specification) or a stand alone spread spectrum device. In a GPON configuration, the optical modem 209 has an interface that does not interfere with the GPON network signaling. The optical coupler 203 illustrates one method of fiber insertion. In this case, the UCM 201 uses an optical directional coupler of the proper value to allow the device to interface with the rest of the network.

The UCM 201 may include at least one meter interface coupled to the optical modem 209 for interfacing the smart meter 112 or other utility meters (e.g., utility meter 119). The interface to the meter 112 may be any one of several interface configurations. The UCM 201 may include multiple interface options to provide flexibility to match any of the many different manufacturers while also being compatible with both the GPON and/or RFoG FTTH technologies. As shown, the UCM 201 includes a meter interface 213 which further couples the module 201 to the smart meter 112 via a suitable connector 215 or the like. In one embodiment, the module 201 is powered from the smart meter 112 in which the power supply converts power from the smart meter 112 via the connector 215. Alternatively, the module 201 may receive power from an alternative power source. Examples of alternative sources include an internal or external power converter (not shown), an internal or external battery (which may or may not be rechargeable) (not shown), an external solar panel, etc.

The UCM 201 may also include a wired network interface, such as including a network connector 217 or the like and a network controller 219 coupled to the optical modem 209. The network interface may be configured according to Ethernet or the like. The network controller 219 may be provided to communicate with a smart meter 112 which is network-enabled and already has the network interface built into the smart meter 112. The network controller 219 may be implemented according to any suitable configuration, such as, for example, a standard 10/100 Base-T Ethernet interface.

The network controller 219 may be used instead of the meter interface 213 to establish communications with the smart meter 112 and/or the utility meter 119 and/or other utility devices, such as 123, 125, 127, etc. In one embodiment, the connector 217 is a single connector in which an external router, hub or switch establishes a local area network (LAN) or the like. Alternatively, a network switch and/or a network router may be incorporated within the UCM 201 and multiple connectors maybe provided for an expanded network.

It is appreciated that the UCM 201 maybe configured with either one of the meter interface 213 or the network controller 219 depending upon the capabilities of the smart meter 112. The UCM 201 may be implemented with both for increased flexibility for different installation sites. For example, the meter interface 213 may be enabled for establishing communications with the smart meter 112 and the utility meter 119 among other utility meters and the like. The network controller 219 may be configured for establishing other remote communications for one or more of the home network devices.

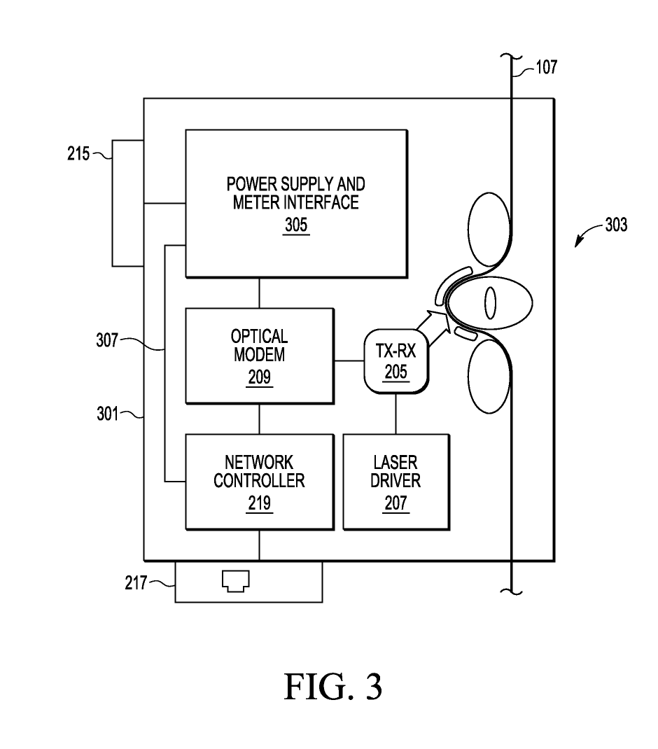

FIG. 3 is a block diagram of another exemplary embodiment of a UCM 301 which may be used as the UCM 101. The UCM 301 is substantially similar to the UCM 201 except using an alternative fiber insertion method. Also, the power supply 211 and the meter interface 213 are shown replaced by a single power supply and meter interface 305. Similar components assume identical reference numerals. As shown, the UCM 301 includes the optical transceiver 205, the laser driver 207, the optical modem 209, the network connector 217 and the network controller 219 configured to operate in similar manner. The power supply and meter interface 305 couples to the connector 215 for interfacing the smart meter 112 as previously described.

The fiber insertion method of the UCM 301 is an optical fiber tap 303 which is implemented in accordance with that shown in U.S. Pat. No. 5,037,107, entitled “Optical Fiber Tap Utilizing Reflector And Resilient Closure.” The tap 303 replaces the optical coupler 203. In this case the fiber segment 107 is passed through the UCM 301 with little or no modification to enable optical communications. Optical splicing and the like is eliminated.

FIG. 3 also illustrates another method of receiving power. The network controller 219 may be configured according to Ethernet, which may further be configured to support Power Over Ethernet (POE). A power link 307 is shown coupled between the network controller 219 and the power supply and meter interface 305 in which the network controller 219 provides or otherwise relays power. In this case, an external device coupled via the network connector 217 may provided power to the UCM 301.

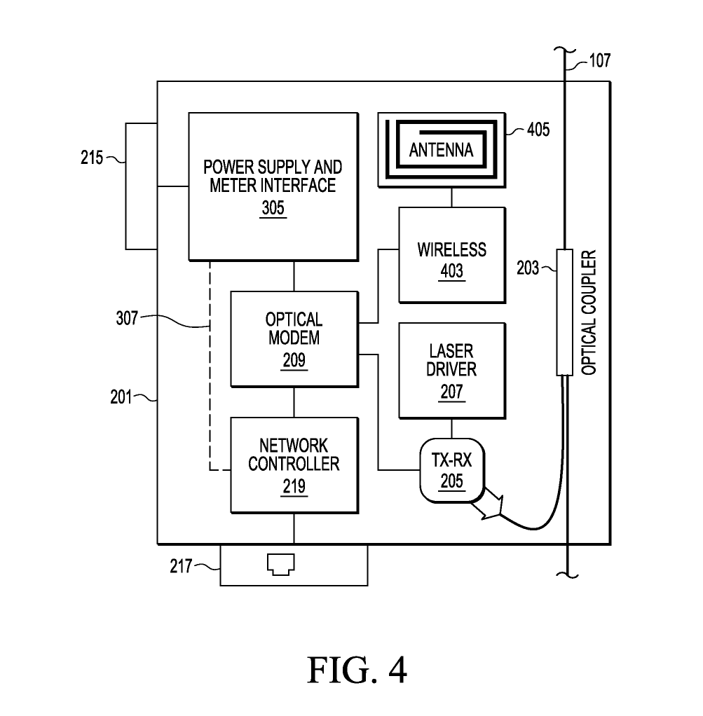

FIG. 4 is a block diagram of another exemplary embodiment of a UCM 401 which may be used as the UCM 101. The UCM 401 is substantially similar to the UCM 201 in which similar components assume identical reference numerals. In this case, the UCM 401 includes the optical coupler 203, the laser driver 207 and optical transceiver 205, the optical modem 209, the network controller 219 and connector 217, the power supply and meter interface 305 and the connector 215. The UCM 401 further illustrates a wireless network option to enhance communications flexibility. As shown, the UCM 401 includes a wireless communication device 403 and antenna 405 for enabling wireless communications, such as via a wireless local area network (LAN) or the like.

The wireless communication device 403 enables the UCM 401 to communicate with other meters (e.g., satellite meters) in the general locale of one meter (e.g., master meter) having a fiber optic interface. The wireless communication device 403 may be configured according to any suitable wireless protocol including various Ethernet configurations, any of the WiFi IEEE 802.11 variations, ZigBee IEEE 802.15, etc. In rural applications, the satellite locations may be a barn, well head or poultry building that needs the smart grid interface but not any of the additional communications services. In one embodiment, the wireless communications device 403 is a wireless router for LAN communications according to the wireless Ethernet protocol, although alternative configurations are contemplated.

The wireless communication device 403 may further enable communications with other types of utilities and services, such as the HS system 123, and/or the HVAC system 125, and/or the SM controller 127 and/or the like. In this manner, the UCM 401 enables uni-directional or bidirectional communications with devices for a variety of utilities and/or services, such as various utility services, security systems, heating, HVAC systems, light controllers, swimming pool controllers, home theater devices, network communication systems, etc.

External power may be provided via the network connector 217 if supported by the network controller 219 (e.g., POE or the like). As shown, the power link 307 is shown by a dashed line.

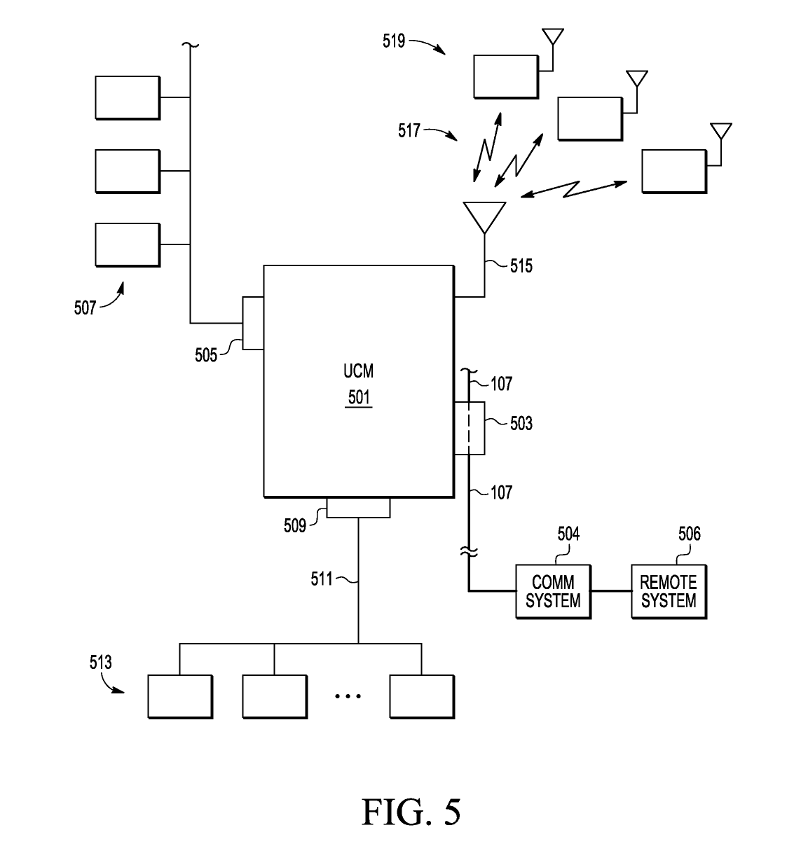

FIG. 5 is a block diagram of an exemplary UCM 501 which may be configured according to any of the UCM configurations described herein (e.g., 101, 201, 301, 401) for interfacing utilities devices implemented according to any of the communication interfaces described herein. The UCM 501 includes an optical fiber interface 503 for interfacing an optical fiber, such as the optical fiber segment 107, for enabling optical communications via an optical network. As understood by those of ordinary skill in the art, the optical fiber interfaces an upstream communication system 504, which is further interfaced with a remote system 506. In this manner, the remote system 506 has communication access to the UCM 501.

The UCM 501 may include a meter interface 505 for interfacing one or more utility meters 507 in a similar manner previously described. The utility meters 507 may represent one or more different types of meter (e.g., electric, gas, water, etc.) and/or may represent multiple meters of a given type. For example, a cluster of electric meters may be provided at a multifamily dwelling or the like (e.g., apartment complex). Each of the utility meters 507 may be configured as either one of a standard meter or a smart meter or the like. In this manner, the UCM 501 enables the remote system 506 to access any of the utility meters 507. Remote access may include simple meter reading functions or may be more sophisticated such as including various remote control functions.

The UCM 501 may further include a wired network interface 509 coupled to one or more network-enabled devices 513 via a wired network 511. The wired network interface 509 may be implemented according to any suitable wired network protocol, including those described herein and/or based on Ethernet configurations and the like. The wired network 511 may represent a local area network (LAN) or a wide-area network (WAN) or the like. The wired network 511 may be according to any suitable architecture, such as Ethernet or the like. The network-enabled devices 513 may include utility meters and may include devices supporting other types of commercial or residential services, such as, for a non-exhaustive list of examples, security systems, heating, HVAC systems, light controllers, swimming pool controllers, home theater devices, network communication systems, etc. In this manner, the UCM 501 enables the remote system 506 to access any of the network-enabled devices 513. Remote access may be uni-directional or bidirectional based on system needs.

The UCM 501 may further include a wireless network interface 515 interfacing one or more wireless network-enabled devices 519 via a wireless network 517. The wireless network interface 515 may be implemented according to any suitable wireless protocol, including those described herein and/or based on Ethernet configurations and the like. The wireless network 517 may represent a wireless LAN (WLAN) or the like. The wireless network 517 may be according to any suitable architecture, such as Ethernet or the like. The wireless network-enabled devices 519 may include utility meters and may include devices supporting other types of commercial or residential services, such as, for a non-exhaustive list of examples, security systems, heating, HVAC systems, light controllers, swimming pool controllers, home theater devices, network communication systems, etc. In this manner, the UCM 501 enables the remote system 506 to access any of the wireless network-enabled devices 519. Remote access may be uni-directional or bidirectional based on system needs.

It is appreciated that the UCM 501 may include or otherwise omit any of the communication utilities interfaces. Thus, the UCM 501 may include only the meter interface 505, or only the wired network interface 509, or only the wireless network interface 515, or any combination of these interfaces.

Although the present invention has been described in considerable detail with reference to certain preferred versions thereof, other versions and variations are possible and contemplated. Those skilled in the art should appreciate that they can readily use the disclosed conception and specific embodiments as a basis for designing or modifying other structures for carrying out the same purposes of the present invention without departing from the spirit and scope of the invention.

1. A utilities communications module, comprising:
an optical fiber interface which enables remote communications via an optical network;
an optical modem, coupled to said optical fiber interface, which converts between optical and electrical communications; and
at least one utilities interface, coupled to said optical modem, which enables remote communications with at least one local utility device.

2. The utilities communications module of claim 1, wherein said optical fiber interface comprises a selected one of an optical coupler and an optical tap.

3. The utilities communications module of claim 1, wherein said optical fiber interface comprises an optical transceiver.

4. The utilities communications module of claim 1, wherein said at least one utilities interface comprises a meter interface which enables interfacing with at least one local meter.

5. The utilities communications module of claim 1, wherein said at least one utilities interface comprises a smart meter interface which enables communications with at least one local smart meter.

6. The utilities communications module of claim 5, wherein smart meter interface is configured for enabling bidirectional communications with at least one of a smart electric meter, a smart gas meter and a smart water meter.

7. The utilities communications module of claim 1, wherein said at least one utilities interface enables remote meter reading.

8. The utilities communications module of claim 1, wherein said at least one utilities interface comprises a local network interface.

9. The utilities communications module of claim 8, wherein said local network interface comprises a wired network interface.

10. The utilities communications module of claim 8, wherein said local network interface comprises a wireless network interface.

11. The utilities communications module of claim 8, wherein said local network interface is configured according to Ethernet.

12. The utilities communications module of claim 1, wherein said at least one utilities interface comprises a local network interface which enables communications with at least one network-enabled utility meter.

13. The utilities communications module of claim 1, wherein said at least one utilities interface comprises a local network interface which enables communications with network-enabled devices coupled via said local network interface.

14. The utilities communications module of claim 1, wherein said at least one utilities interface comprises a meter interface and a local network interface.

15. The utilities communications module of claim 14, wherein said meter interface comprises a smart meter interface.

16. The utilities communications module of claim 1, wherein said at least one utilities interface comprises a meter interface, a wired local network interface and a wireless local network interface.

17. The utilities communications module of claim 1, further comprising a power supply receiving power via said at least one utilities interface.

18. The utilities communications module of claim 1, wherein said at least one utilities interface enables bidirectional communications with at least one home monitoring controller.

19. The utilities communications module of claim 1, wherein said at least one utilities interface enables bidirectional communications with at least one home security controller.

20. The utilities communications module of claim 1, wherein said at least one utilities interface enables bidirectional communications with at least one smart home controller.
